(19) United States
(12) Patent Application Publication
(10) Pub. No.: US 2013/0073159 A1
(43) Pub. Date: Mar. 21, 2013

(54) SYSTEM FOR CONTROLLING A TORQUE TRANSFER ACTUATOR WITH MULTIPLE MODES OF OPERATION

(71) Applicants: Jean-Marie Foret, Saint-Marcel (FR); Francois Foussard, Versailles (FR); Stephane Guegan, Versailles (FR); Alessandro Monti, La Garenne Colombes (FR)

(72) Inventors: Jean-Marie Foret, Saint-Marcel (FR); Francois Foussard, Versailles (FR); Stephane Guegan, Versailles (FR); Alessandro Monti, La Garenne Colombes (FR)

(73) Assignee: RENAULT s.a.s., Boulogne-Billancourt (FR)

(21) Appl. No.: 13/640,415

(22) PCT Filed: Apr. 11, 2011
(86) PCT No.: PCT/FR2011/050827

§ 371 Date: Nov. 28, 2012

(30) Foreign Application Priority Data
Apr. 12, 2010 (FR) 1052768

(51) Int. Cl. B60K 17/346; B60K 28/16

(52) U.S. Cl. CPC B60K 17/3465; B60K 28/16
USPC 701/69

(57) ABSTRACT

A system for controlling a torque transfer actuator for a four-wheel drive motor vehicle, including: a determining mechanism and a system for preventing the wheels from locking; a controller preventing the wheels from locking; and a controller for the torque transfer actuator, configured to interact to transmit a torque transfer command destined for the torque transfer actuator.

The present invention concerns the technical field of motor vehicle transmissions, and more particularly the field of the control of motor vehicle transmissions.

Motor vehicle transmissions historically comprise two-wheel drive transmissions for the majority of vehicles and four-wheel drive transmissions for all-terrain vehicles.

Further to the specificities inherent in these various vehicles, four-wheel drive vehicles have a high fuel consumption and poor on-road performance.

For some years, new vehicles with integral transmission have been pushing the boundaries of the previously established limits. These vehicles are characterized by variable torque transfer between the front drive wheel and axle set and the rear drive wheel and axle set.

Precise control of this type of transmission makes it possible to reconcile performance and safety, both on the road and on all-terrain.

American U.S. Pat. No. 5,752,211 describes a control method which improves the fuel consumption by determining an offset value. This offset value varies as the cube of the speed, and is subtracted from the torque distribution command. This control method makes it possible to improve the difference between the speed of the front set and the speed of the rear set during quasi-static running phases.

European Patent Application EP 1188597 describes a method for distributing the torque between the front and rear sets as a function of detection of tire diameter variation due to wear or changing.

European Patent Application EP 1275549 describes a method for distributing the torque between the front and rear sets as a function of various signals such as the rotation speeds of the wheels and the position of the accelerator pedal. This method improves the performance of the vehicle by improving the ratio between the speed of the front set and the speed of the rear set, but it does not describe a method for determining the setpoint.

Japanese Patent JP 10119598 describes a control method applied to a four-wheel drive vehicle, the main drive wheels of which are located on the rear set. The system is able to transfer a part of the torque of the rear drive wheels to the front wheel and axle set. This transfer is activated when the rear drive wheels spin.

American U.S. Pat. No. 5,247,443 describes a method for distributing the torque between the front and rear sets as a function of the difference between the rotation speeds of the front and rear sets. The method also modifies the threshold for detection of skidding if braking is engaged. This method optimizes the performance of the vehicle by optimizing the skidding, but does not take into account the intensity of the braking in the determination of the torque distribution.

European Patent Application EP 1627763 describes a method which takes braking into account in the distribution of the torque between the front and rear sets.

When the torque transfer is active and the wheel antilock is engaged, it is possible to reach a situation in which the all-terrain drive mode (four-wheel drive) is disengaged at the instigation of the driver. Such a situation degrades the driving comfort and may be dangerous. Although the prior art documents describe devices for controlling a torque transfer system, none of these documents describes a control device which takes into account the operating conditions of the system for wheel antilock during braking (ABS) and the torque transfer system (ETC). Such systems are therefore incapable of taking control of the situation described above.

There is a need to take into account the activation of the system for wheel antilock during braking (ABS) and the torque transfer system (ETC) when determining the torque transfer.

The present invention relates to a method for controlling a torque transfer actuator, which is able to take into account the operating conditions of the system for wheel antilock during braking and the torque transfer system.

The present invention also relates to a system for controlling a torque transfer actuator, which is able to take into account the operating conditions of the system for wheel antilock during braking and the torque transfer system.

According to one embodiment, a system for controlling a torque transfer actuator for a four-wheel drive motor vehicle comprises determination means and a wheel antilock system. The control system comprises a wheel antilock control means and a control means of the torque transfer actuator, which are able to cooperate in order to emit the torque transfer command to the torque transfer actuator.

The wheel antilock control means may be able to determine a wheel antilock command as a function of the torque transfer command received from the control means of the torque transfer actuator,

it being possible for the control means of the torque transfer actuator to be able to determine a torque transfer command as a function of the wheel antilock command.

The control system allows the wheel antilock and the torque transfer to cooperate, which makes it possible to form a torque transfer setpoint which is not erroneously determined because of unjustified engagement of the wheel antilock.

The control system may comprise a manual control component connected to the control means of the torque transfer actuator, and

it being possible for the manual control component to be able to occupy a plurality of positions and to be manipulated by the driver of the vehicle, and to be able to emit a signal according to the position selected by the driver.

The control system may comprise a means for determining the driving situation, able to emit a control signal to the driven switch as a function of the signals received from the determination means and the torque transfer command received from the control means of the torque transfer actuator, and it may comprise a driven switch able to emit a wheel lock detection signal.

The control system may comprise a first wheel lock detection means and a second wheel lock detection means, each connected to a terminal of the controlled switch and each able to determine the existence of a wheel lock during braking as a function of the rotation speed signals of each wheel which are received from the determination means.

The control system may comprise a means for estimating the level of braking, able to emit a signal as a function of the pressure signal in the brake circuit, which is received from the determination means, a logical operator of the AND type able to emit a wheel antilock command relating to the operational state of the wheel antilock control means, as a function of the signals received from the controlled switch and from the means for estimating the level of braking.

The control system may comprise a means for determining the activity of the wheel antilock system, which is able to determine a control signal for triggering the wheel antilock system as a function of the signals received from the determination means and the wheel antilock command received from the wheel antilock control means.

The control system may comprise a driving mode control means able to determine the driving mode to be applied to the torque transfer actuator as a function of signals received from the determination means and the control signal for triggering the wheel antilock system received from the means for determining the activity of the wheel antilock system, the driving mode control means being able to emit a mode control signal.

The control system may comprise a torque setpoint determination means and a switching means, the torque setpoint determination means being able to determine the torque setpoints to be applied to the torque transfer actuator for each driving mode selectable by the driver, as well as for a braking mode, the switching means being able to emit a torque transfer command to the torque transfer actuator as a function of the mode control signal received from the driving mode control means and the signals received from the torque setpoint determination means.

According to another embodiment, a torque transfer control method for a four-wheel drive motor vehicle having wheel antilock control and torque transfer control comprises steps in which:

the wheel antilock command depends on the torque transfer command, and

the torque transfer command depends on the wheel antilock command.

The wheel antilock command may depend on the torque transfer command, in particular on the driving mode request of the driver, the status of the torque transfer system and the driving mode active in the torque transfer system.

A wheel lock detection signal may be determined as a function of at least two wheel lock detection modes and as a function of the speed of the vehicle and the torque transfer command, in particular the driving mode request of the driver, the status of the torque transfer system and the driving mode active in the torque transfer system.

A first wheel lock detection mode may be selected if the driving mode request of the driver is not all-terrain, if the driving mode active in the torque transfer system is not all-terrain, if the speed of the vehicle is greater than a threshold value or if a malfunction of the torque transfer actuator other than a thermal malfunction is detected.

A second wheel lock detection mode may be selected if the first wheel lock detection mode has not been activated, the second wheel lock detection mode having a lower detection sensitivity than the detection sensitivity of the first wheel lock detection mode.

A braking detection signal may be determined if the pressure of the brake system is greater than a threshold value,

the wheel antilock command may be determined as a function of the wheel lock detection signal and the braking detection signal, and

a control signal for triggering the wheel antilock system may be determined as a function of the speed of the vehicle, the wheel antilock command, the driving mode request of the driver and a braking request signal.

A torque transfer setpoint in two-wheel drive mode, a torque transfer setpoint in four-wheel drive mode, a torque transfer setpoint in all-terrain four-wheel drive mode and a torque transfer setpoint in braking mode may be determined,

a torque transfer setpoint may be selected as a function of the speed of the vehicle, the driving mode request of the driver, depression of the brake pedal, activation of the handbrake and a control signal for triggering the wheel antilock system, and

the torque transfer command may be emitted as a function of the torque transfer setpoint selected.

Other objects, characteristics and advantages will become apparent on reading the following description, which is given solely by way of nonlimiting example and is provided with reference to the appended drawings, in which:

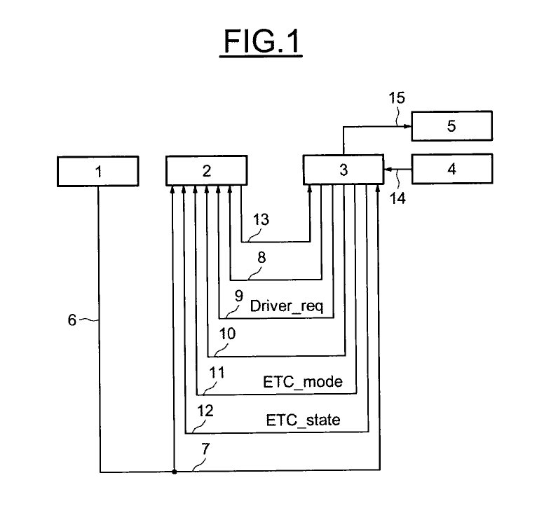

FIG. 1 illustrates the main elements contained in a system for controlling a torque transfer actuator;

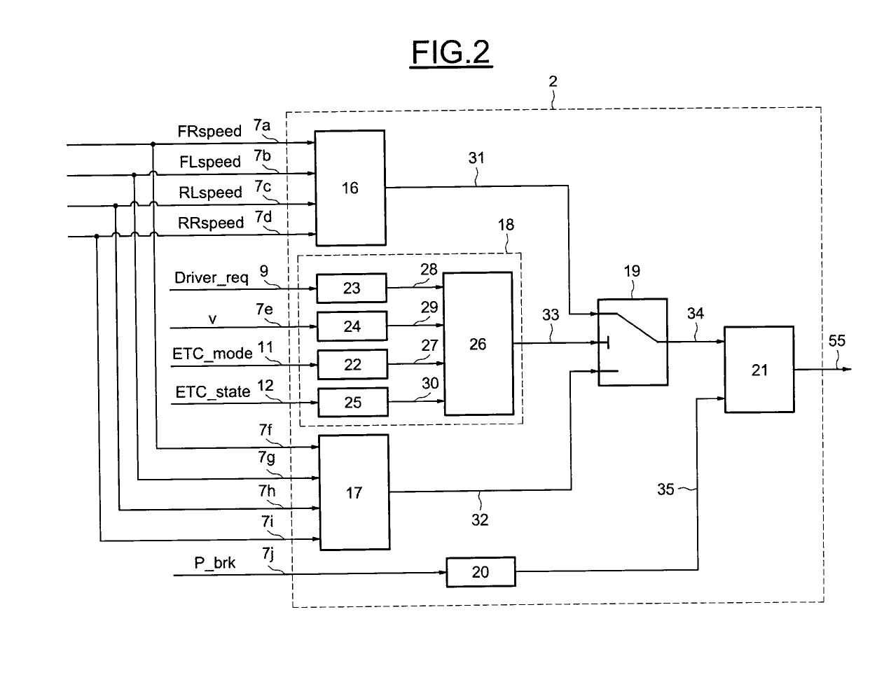

FIG. 2 illustrates the main elements contained in the means for controlling for wheel antilock during braking; and

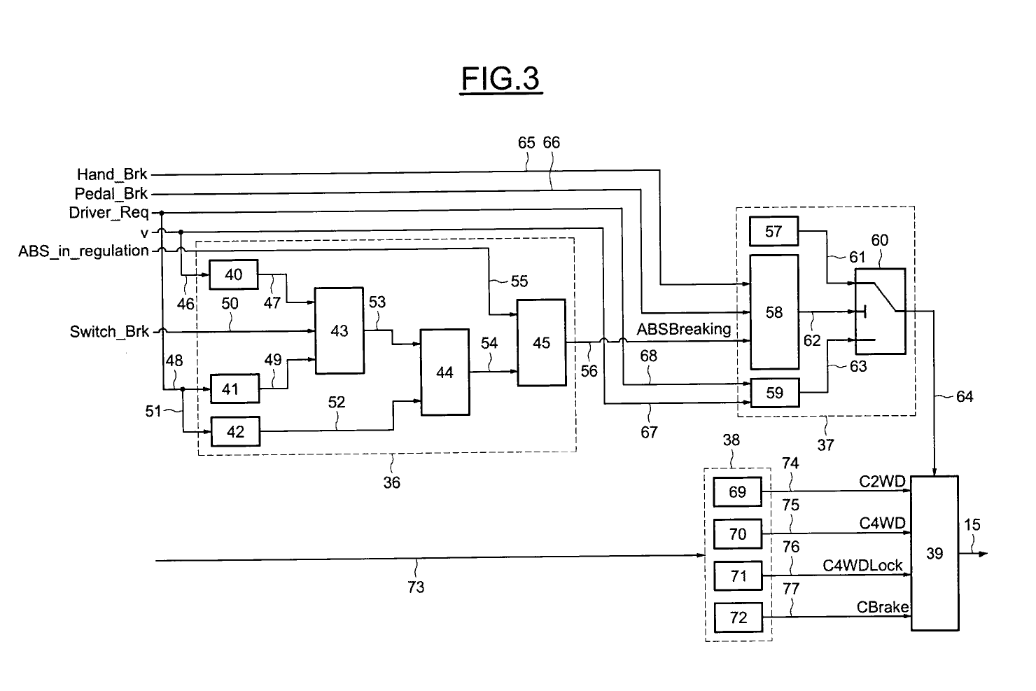

FIG. 3 illustrates the main elements contained in the control means of the torque transfer actuator.

FIG. 1 shows an electronic control system with which a four-wheel drive motor vehicle (not shown) is equipped. The control system illustrated comprises determination means 1, a wheel antilock control means 2, a control means 3 of the torque transfer actuator, a manual control component 4 and a torque transfer actuator 5.

The determination means 1 are connected to the wheel antilock control means 2 of the vehicle via the connection 6 and to the control means 3 of the torque transfer actuator via the connection 7.

The determination means 1 may comprise physical sensors or calculation means able to determine the quantities required on the basis of a model and data provided by other sensors.

The wheel antilock control means 2 is connected at its output to the control means 3 of the torque transfer actuator via the connections 8 to 12 and at its input via the connection 13.

The manual control component 4 is connected at its output to the control means 3 of the torque transfer actuator 3 via a connection 14. The torque transfer actuator 5 is connected at its input to the control means 3 of the torque transfer actuator via the connection 15.

The control means 3 of the torque transfer actuator cooperates with the wheel antilock control means 2 in order to determine a torque transfer command for the torque transfer actuator 5. The torque transfer actuator 5 transfers to the rear axle of the vehicle all or part of the torque delivered to the front axle by the propulsion motor, for example an internal combustion engine, an electric motor or a hybrid motor. A plurality of transfer modes may be activated. The two-wheel drive mode (2WD) suppresses the torque transfer from the front axle to the rear axle. Only the front two wheels (in the case of a traction vehicle) are drive wheels.

The all-terrain four-wheel drive mode (4WDLock) comprises torque transfer from the front axle to the rear axle so that the same torque value is exerted on the front axle as on the rear axle.

Finally, the four-wheel drive mode (4WD) comprises transfer of a portion of the torque from the front axle to the rear axle. The portion of torque transferred to the rear axle may be fixed or variable, and is generally less than the torque transferred in the all-terrain four-wheel drive mode (4WDLock).

The determination means 1 emit signals, intended in particular for the wheel antilock control means 2 and the control means 3 of the torque transfer actuator, relating in particular to the depression of the clutch pedal, the gear ratio engaged, the depression of the accelerator pedal, the speed v of the vehicle, the speed FRspeed of the front-right wheel of the vehicle, the speed FLspeed of the front-left wheel of the vehicle, the speed RRspeed of the rear-right wheel of the vehicle, the speed RLspeed of the rear-left wheel of the vehicle, and the pressure P_brk in the brake circuit.

The wheel antilock control means 2 emits a wheel antilock command ABS_in_regulation to the control means 3 of the torque transfer actuator.

The control means 3 of the torque transfer actuator emits a torque transfer command to the wheel antilock control means 2, comprising at least one signal relating to the traction mode required by the driver Driver_req, a signal relating to the active torque transfer mode ETC_mode, a signal relating to the state of the actuator ETC_State, and a signal relating to the torque transfer setpoint.

The signal relating to the state of operation of the torque transfer actuator ETC_State can take a plurality of values, including in particular the value “normal”, the value “high temperature alert”, the value “malfunction due to overheating” and the value “other malfunction”.

The signal relating to the traction mode required by the driver Driver_req and the signal relating to the active torque transfer mode ETC_mode can take a plurality of values, including in particular the value “two-wheel drive” (2WD), the value “four-wheel drive in normal driving mode” (4WD) and the value “four-wheel drive in all-terrain driving mode” (4WDLock).

Other signals may be emitted, for example the estimate of the torque transferred, or a measurement of the torque transferred. Furthermore, the signals passing between a plurality of elements of the control device may equally well be provided with an individual wire connection, or be subject to multiplexing or transport by data bus. These connection modes are given only by way of nonlimiting example.

The manual control component 4, which can be actuated directly by the driver of the vehicle, emits at least one signal to the control means 3 of the torque transfer actuator, relating to the selection of a traction mode by the driver. The traction modes from which the selection may be made comprise in particular a two-wheel drive mode (2WD), a four-wheel drive mode (4WD) and an all-terrain four-wheel drive mode (4WDLock).

The all-terrain four-wheel drive mode (4WDLock) is distinguished from the four-wheel drive mode (4WD) in that it is selected by the driver in order to signal his intention to use the vehicle in all-terrain mode in order to navigate obstacles or cross uneven ground. This implies that wheel lock may take place without a running anomaly having occurred.

FIG. 2 shows the elements included in the wheel antilock control means 2.

The wheel antilock control means 2 comprises a first wheel lock detection means 16, a second wheel lock detection means 17, a means 18 for determining the driving situation, a controlled switch 19, a means 20 for estimating the level of braking, and a logical operator 21 of the AND type.

The first wheel lock detection means 16 receives at its input the speed FRspeed of the front-right wheel of the vehicle, the speed FLspeed of the front-left wheel of the vehicle, the speed RLspeed of the rear-left wheel of the vehicle and the speed RRspeed of the rear-right wheel of the vehicle, which come from the determination means 1 via connections 7a, 7b, 7c and 7d.

The second wheel lock detection means 17 also receives at its input the speed FRspeed of the front-right wheel of the vehicle, the speed FLspeed of the front-left wheel of the vehicle, the speed RLspeed of the rear-left wheel of the vehicle and the speed RRspeed of the rear-right wheel of the vehicle, which come from the determination means 1 via connections 7f, 7g, 7h and 7i.

The means 18 for determining the driving situation receives at its input the speed of the vehicle v, coming from the determination means 1 via a connection 7e, and it furthermore receives from the control means of the torque transfer actuator a torque transfer command comprising a signal relating to the traction mode required by the driver Driver_req via the connection 9, a signal relating to the active torque transfer mode ETC_mode via the connection 11, and a signal relating to the state of the torque transfer actuator ETC_state via the connection 12.

The first wheel lock detection means 16 and the second wheel lock detection means 17 are connected to the input of the driven switch 19 via the connections 31 and 32, respectively. The driven switch 19 is connected by its control terminal to the means 18 for determining the driving situation via the connection 33.

The means 18 for determining the driving situation itself comprises a means 22 for determining the active driving mode, a means 23 for determining the driving mode required by the driver, a means 24 for comparing the speed of the vehicle with a threshold speed, a means 25 for determining a malfunction of the torque transfer actuator and a logical operator 26 of the OR type. The means 22 for determining the active driving mode, the means 23 for determining the driving mode required by the driver, the means 24 for comparing the speed of the vehicle with a threshold speed and the means 25 for determining a malfunction of the torque transfer actuator are connected to the logical operator of the OR type via links 27, 28, 29 and 30, respectively. The logical operator 26 of the OR type shares its output with the means 18 for determining the driving situation.

The output of the driven switch 19 is connected to an input of the logical operator 21 of the AND type via the connection 34.

The means 20 for estimating the level of braking receives at its input the pressure P_brk in the brake system via the connection 7j coming from the determination means 1. Furthermore, the means 20 for estimating the level of braking is connected at its output to the logical operator 21 of the AND type via the connection 35. The logical operator 21 of the AND type shares its output 55 with that of the wheel antilock control means 2.

The first wheel lock detection means 16 is adapted to detect wheel lock when the vehicle is not in an all-terrain mode. Conversely, the second wheel lock detection means 17 is adapted to detect wheel lock when the vehicle is in an all-terrain mode. Among the driving modes described above, the two-wheel drive mode (2WD) and the four-wheel drive mode (4WD) are not all-terrain modes, while the all-terrain four-wheel drive mode (4WDLock) is an all-terrain mode. The first wheel lock detection means 16 and the second wheel lock detection means 17 differ from one another by less strict activation conditions of the second detection means 17.

The first wheel lock detection means 16 and the second wheel lock detection means 17 are active in parallel. The means 18 for determining the driving situation is capable of determining which activation condition of the wheel antilock system should be applied among that of the first detection means 16 and that of the second detection means 17.

The means 22 for determining the active driving mode compares the value carried by the received signal ETC_mode of the control means 3 of the torque transfer actuator with a stored value characteristic of four-wheel drive operation in all-terrain mode (4WDLock). If the two values are the same, the means 22 for determining the active driving mode emits a logical value “false” at its output, otherwise a logical value “true” is emitted.

The means 23 for determining the driving mode required by the driver compares the value carried by the received signal Driver_req of the control means 3 of the torque transfer actuator with a stored value characteristic of four-wheel drive operation in all-terrain mode (4WDLock). If the two values are the same, the means 23 for determining the driving mode required by the driver emits a logical value “false” at its output, otherwise a logical value “true” is emitted.

The comparison means 24 compares the value carried by the received signal v of the determination means 1 with a stored threshold speed and emits a logical value “true” at its output if the value v is greater than the stored threshold speed, otherwise a logical value “false” is emitted.

The means 25 for determining a malfunction of the torque transfer actuator compares the value carried by the received signal ETC_state of the control means 3 of the torque transfer actuator with a stored value characteristic of a detected fault other than a malfunction due to heat. The means 25 for determining a malfunction of the torque transfer actuator emits a logical value “true” at its output if the value ETC_state is equal to the stored value, otherwise a logical value “false” is emitted.

The logical values emitted at the outputs of the means 22 for determining the active driving mode, the means for determining the driving mode required by the driver, the means 24 for comparing the speed of the vehicle with a threshold speed and the means 25 for determining a malfunction of the torque transfer actuator are connected via their outputs to the logical operator 26 of the OR type, which emits a logical signal “true” if at least one of the logical values received on its inputs is a logical value “true”.

The driven switch 19 emits a wheel lock detection signal at its output. The wheel lock detection signal is equal to the logical signal received from the first determination means 16 if the control signal received from the determination means 18 carries a logical value “true”, otherwise the wheel lock detection signal is equal to the logical signal received from the second determination means 17.

The means 20 for estimating the level of braking compares the value carried by the signal P_brk received from the determination means 1 with a stored value Pthreshold and emits a logical value “true” at its output if the value P_brk is greater than or equal to the value Pthreshold, otherwise a logical value “false” is emitted.

The logical operator 21 of the AND type emits a logical value “true” at its output if the two received signals respectively coming from the driven switch 19 and the means 20 for estimating the level of braking carry a logical value “true”, otherwise a signal carrying the logical value “false” is emitted.

Since the output 55 of the logical operator 21 of the AND type is the same as the output of the control means 2, the signal emitted by the logical operator 21 of the AND type is also the signal emitted by the control means 2. This signal corresponds to the wheel antilock command ABS_{—} in_{—} regulation.

FIG. 3 illustrates the main elements contained in the control means 3 of the torque transfer actuator, among which there are a means 36 for determining the activity of the wheel antilock system, a means 37 for controlling the driving mode, a means 38 for determining the torque setpoints, and a controlled switching means 39. Other means (not shown) make it possible to determine the signal relating to the traction mode required by the driver Driver_req, the signal relating to the active torque transfer mode ETC_mode, and the signal relating to the state of the torque transfer actuator ETC_state.

The means 36 for determining the activity of the wheel antilock system comprises a means 40 for comparing the speed of the vehicle with a threshold speed, a first means 41 for comparing the driving mode request of the driver and a second means 42 for comparing the driving mode request of the driver, a logical operator 43 of the AND type, a logical operator 44 of the OR type and a logical operator 45 of the AND type.

The means 40 for comparing the speed of the vehicle with a threshold speed is connected at its input to the determination means 1 via the connection 46 and at its output to the logical operator 43 of the AND type via the connection 47.

The first means 41 for comparing the driving mode request of the driver is connected at its input to the manual control component 4 via the connection 48 and at its output to the logical operator 43 of the AND type via the connection 49.

The logical operator 43 of the AND type is connected at its input to the determination means 1 via a connection 50 carrying a braking request signal Switch_brk, and at its output to the logical operator 44 of the OR type via the connection 53.

The second means 42 for comparing the driving mode request of the driver is connected at its input to the manual control component 4 via the connection 51 carrying the signal relating to the traction mode required by the driver Driver_req, and at its output to the logical operator 44 of the OR type via the connection 52.

The logical operator 44 of the OR type is connected at its output via the connection 54 to the logical operator 45 of the AND type.

The logical operator 45 of the AND type is also connected at its input to the wheel antilock control means 2 via the connection 55. The logical operator 45 of the AND type receives the wheel antilock command ABS_{—} in_{—} regulation via the connection 55.

The output of the logical operator 45 of the AND type is the same as the output of the means 36 for determining the activity of the wheel antilock system and is connected to the driving mode control means 37 via the connection 56.

The means 36 for determining the activity of the wheel antilock system receives a value v of the speed of the vehicle via the connection 46. This value is compared by the speed comparison means 40 with a stored value Vthreshold. A logical value “true” is emitted at its output if the value of the speed v is greater than or equal to the value Vthreshold, otherwise the logical value “false” is emitted.

The means 36 for determining the activity of the wheel antilock system receives via the connection 50 a logical value coming from the determination means 1 and carrying the value “true” if the brake pedal is depressed.

The value Driver_req is received via the connection 48 from the control means 3 of the torque transfer actuator. The first means 41 for comparing the driving mode request of the driver compares the value Driver_req with the stored value 4WDLock. If the comparison is verified, a logical value “true” is emitted at the output of the first comparison means 41, otherwise the logical value “false” is emitted.

Likewise, the second means 42 for comparing the driving mode request of the driver compares the value Driver _req with the stored value 4WDLock. If the comparison is verified, a logical value “false” is emitted at the output of the second comparison means 42, otherwise a logical value “true” is emitted.

The braking request signal Switch_brk carried by the connection 50 coming from the determination means is of the logical type. The signal Switch_brk takes the logical value “false” when no braking is required, or if the braking detection sensor is not reliable. The signal Switch_brk takes the logical value “true” if braking is detected, regardless of the amplitude of the braking requested.

The logical operator 43 of the AND type receives at its input the logical signals emitted by the speed comparison means 40 and by the first means 41 for comparing the driving mode request of the driver and the signal carried by the connection 50. If all these signals carry a logical value “true”, the logical operator 43 of the AND type emits a logical value “true” at its output, otherwise a logical value “false” is emitted.

The logical operator 44 of the OR type receives at its input the logical signals emitted by the logical operator 43 of the AND type and by the second means 42 for comparing the driving mode request of the driver. If at least one of these signals carries a logical value “true”, the logical operator 44 of the OR type emits a logical value “true” at its output, otherwise a logical value “false” is emitted.

The means 36 for determining the activity of the wheel antilock system receives via the connection 55 the wheel antilock command ABS_{—} in_{—} regulation coming from the wheel antilock control means 2.

The logical operator 45 of the AND type receives as input the logical signal emitted by the logical operator 44 of the OR type and the wheel antilock command ABS_{—} in_{—} regulation. If all these signals carry a logical value “true”, the logical operator 45 of the AND type emits at its output a control signal for triggering the wheel antilock system ABSBraking carrying a logical value “true”, otherwise a logical value “false” is emitted.

In other words, whether or not the driver requires an all-terrain four-wheel drive mode (4WDLock) is determined. If the all-terrain four-wheel drive mode (4WDLock) is required, if the speed of the vehicle is greater than or equal to a threshold speed and if the wheel antilock is active, the wheel antilock system (ABS) is triggered. Likewise, if a mode other than the four-wheel drive mode is required and if the wheel antilock is active, the wheel antilock system (ABS) is triggered. In other cases, the wheel antilock system (ABS) is not triggered. This is the case in particular if the wheel antilock is inactive. The wheel antilock system (ABS) is triggered or not triggered by the emission of a control signal for triggering the wheel antilock system ABSBraking at the output of the means 36 for determining the activity of the wheel antilock system. This signal ABSBraking carries a logical value determined by the logical operator 45 of the AND type.

The means 37 for controlling the driving mode comprises a memory 57, a logical operator 58 of the OR type, a means 59 for determining the driving mode to be activated, and a controlled switch 60.

The controlled switch 60 is connected at its input via a connection 61 to the memory 57, and via the connection 63 to the means 59 for determining the driving mode to be activated. The controlled switch 60 is furthermore connected at its input by its control terminal to the logical operator 58 of the OR type via the connection 62.

The logical operator 58 of the OR type is connected at its input to the means 36 for determining the activity of the wheel antilock system via the connection 56, carrying the control signal for triggering the wheel antilock system ABSBraking, and to the determination means 1 via the connection 65 and the connection 66.

The means 59 for determining the driving mode to be activated is connected at its input to the determination means 1 via the connection 67, which branches off from the connection 46, and the connection 68, which branches off from the connection 48.

The controlled switch 60 is connected at its output to the controlled switching means 39 via the connection 64.

The logical operator 58 of the OR type receives from the determination means 1 a logical activation signal of the handbrake Hand_Brk via the connection 65, and a logical activation signal of depression of the brake pedal Pedal_Brk via the connection 66. The logical operator 58 of the OR type emits a logical value “true” at its output if at least one of the signals at its input carries the logical value “true”, otherwise a value “false” is emitted.

The memory 57 emits to the controlled switch 60 a signal for controlling the switching means 39 which is able to cause switching of said switching means 39 so that the braking torque setpoint is emitted at the output of the switching means 39.

The means 59 for determining the driving mode to be activated receives at its input a signal carrying the request of the driver Driver_req via the connection 68, and the speed v of the vehicle via the connection 67, and it may receive other data, for example the external temperature. At its output, the means 59 for determining the driving mode to be activated emits a control signal to the controlled switch 60 in order to control the switching means 39. This control signal emitted by the determination means 59 is able to cause switching of said switching means 39 so that the torque setpoint corresponding to the driving mode determined by the means 59 for determining the driving mode to be activated is applied.

The controlled switch 60 transmits the signal received from the memory 57 to the switching means 39 if the logical signal received on its control terminal coming from the logical operator 58 of the OR type carries the logical value “true”. If the logical signal received on the control terminal coming from the logical operator 58 of the OR type carries the logical value “false”, the signal received from the means 59 for determining the driving mode to be activated is transmitted to the switching means 39.

Thus, the mode control signal emitted at the output of the controlled switch 60 depends on the logical signal received from the logical operator 58 of the OR type.

The means 38 for determining the torque setpoints comprises a means 69 for determining the torque setpoint in two-wheel drive mode (2WD), a means 70 for determining the torque setpoint in four-wheel drive mode (4WD), a means 71 for determining the torque setpoint in all-terrain four-wheel drive mode (4WDLock), and a means 72 for determining the torque setpoint in braking mode. The means 38 for determining the torque setpoints is connected at its input to the determination means 1 via the connection 73.

The controlled switching means 39 is connected at its input to the means 69 for determining the torque setpoint in two-wheel drive mode (2WD) via the connection 74, to the means 70 for determining the torque setpoint in four-wheel drive mode (4WD) via the connection 75, to the means 71 for determining the torque setpoint in all-terrain four-wheel drive mode (4WDLock) via the connection 76, and to the means 72 for determining the torque setpoint in braking mode via the connection 77. The controlled switching means 39 is also connected at its input to the driving mode control means 37 by its control terminal.

The controlled switching means 39 is connected at its output via the connection 15 to the torque transfer actuator 5.

The means 38 for determining the torque setpoints receives on its inputs values coming from the determination means and characterizing the behavior of the vehicle. As a function of these values, the means for determining the torque setpoint in two-wheel drive mode (2WD) determines the torque setpoint in two-wheel drive mode C2WD, the means 70 for determining the torque setpoint in four-wheel drive mode (4WD) determines a torque setpoint in four-wheel drive mode C4WD, the means 71 for determining the torque setpoint in all-terrain four-wheel drive mode (4WDLock) determines the torque setpoint in all-terrain four-wheel drive mode C4WDLock and the means 72 for determining the torque setpoint in braking mode determines the torque setpoint in braking mode CBrake. The determination of the various setpoints is known to the person skilled in the art. It should be noted that the torque setpoint in braking mode CBrake may be a constant value, or a value dependent on the speed of the vehicle or other parameters.

The controlled switching means 39 emits a torque transfer command to the torque transfer actuator 5. The torque transfer command is equal to the torque setpoint corresponding to the signal received from the means 37 for controlling the driving mode.

In other words, if braking is detected, the torque setpoint in braking mode CBrake is applied according to the control signal emitted by the memory 57, otherwise the switching means 39 determines the torque setpoint to be applied as a function of the control signal emitted by the means 59 for determining the driving mode to be activated.

Furthermore, the control means 3 of the torque transfer actuator is able to emit a logical deactivation signal to the wheel antilock control means 2. This signal is emitted when a bridge crossing situation is detected as a function of the speed of each wheel, the motor torque and the torque transferred to the rear axle.

The conditions for detection of a bridge crossing situation are a sum of the rotation speeds of two wheels on a diagonal (for example front-left wheel and rear-right wheel) less than a first threshold value, a sum of the rotation speeds of the other two wheels greater than a second threshold value, and a torque transferred to the rear axle greater than a third threshold value.

If these three conditions are satisfied for a time greater than a stored time, the deactivation signal is emitted. The emission of the signal is stopped as soon as one of these conditions is no longer satisfied.

A bridge crossing situation generally occurs when navigating obstacles in all-terrain mode. Deactivation of the wheel antilock system during the braking makes it possible to avoid oscillation of the logical conditions processed by the control means 3 of the torque transfer actuator, in particular by the wheel antilock command ABS in regulation coming from the wheel antilock control means 2 via the connection 55. An oscillation of the value carried by the wheel antilock command ABS_{—} in_{—} regulation is then capable of leading to an oscillation in the control signal received by the controlled switch 60, which may then generate an oscillation in the torque transfer command emitted by the controlled switching means 39 to the torque transfer actuator 5. Such an oscillation of the torque transfer command may be at best problematic for the driver, and at worst dangerous for the safety of the vehicle.

The control system allows the wheel antilock and the torque transfer to cooperate, which makes it possible to form a torque transfer setpoint which is not erroneously determined by taking into account unjustified triggering of the wheel antilock.

1-16. (canceled)

17. A system for controlling a torque transfer actuator for a four-wheel drive motor vehicle, comprising:
determination means and a wheel antilock system; and
a wheel antilock control means and a control means of the torque transfer actuator, configured to cooperate to emit a torque transfer command to the torque transfer actuator.

18. The control system as claimed in claim 17, wherein the wheel antilock control means is configured to determine a wheel antilock command as a function of the torque transfer command received from the control means of the torque transfer actuator; and
the control means of the torque transfer actuator is configured to determine the torque transfer command as a function of the wheel antilock command.

19. The control system as claimed in claim 17, further comprising:
a manual control component connected to the control means of the torque transfer actuator; and
the manual control component is configured to occupy a plurality of positions and to be manipulated by a driver of the vehicle, and is configured to emit a signal according to the position selected by the driver.

20. The control system as claimed in claim 17, further comprising:
means for determining a driving situation, configured to emit a control signal to a driven switch as a function of signals received from the determination means and the torque transfer command received from the control means of the torque transfer actuator; and
a driven switch configured to emit a wheel lock detection signal.

21. The control system as claimed in claim 20, further comprising:
a first wheel lock detection means and a second wheel lock detection means, each connected to a terminal of the controlled switch and each configured to determine existence of a wheel lock during braking as a function of rotation speed signals of each wheel that are received from the determination means.

22. The control system as claimed in claim 20, further comprising:
means for estimating a level of braking, configured to emit a signal as a function of a pressure signal in the brake circuit, which is received from the determination means; and
a logical operator of AND type configured to emit a wheel antilock command relating to an operational state of the wheel antilock control means, as a function of signals received from the controlled switch and from the means for estimating the level of braking.

23. The control system as claimed in claim 22, further comprising:
means for determining activity of the wheel antilock system, which is configured to determine a control signal for triggering the wheel antilock system as a function of signals received from the determination means and the wheel antilock command received from the wheel antilock control means.

24. The control system as claimed in claim 23, further comprising:
a driving mode control means configured to determine a driving mode to be applied to the torque transfer actuator as a function of signals received from the determination means and the control signal for triggering the wheel antilock system received from the means for determining the activity of the wheel antilock system,
the driving mode control means configured to emit a mode control signal.

25. The control system as claimed in claim 24, further comprising:
a torque setpoint determination means and a switching means,
the torque setpoint determination means configured to determine torque setpoints to be applied to the torque transfer actuator for each driving mode selectable by a driver, as well as for a braking mode, and
the switching means configured to emit the torque transfer command to the torque transfer actuator as a function of the mode control signal received from the driving mode control means and the signals received from the torque setpoint determination means.

26. A torque transfer control method for a four-wheel drive motor vehicle having wheel antilock control and torque transfer control, comprising:
controlling a wheel antilock command based on a torque transfer command; and
controlling a torque transfer command based on a wheel antilock command.

27. The control method as claimed in claim 26, wherein the controlling the wheel antilock command based on the torque transfer command is based on a driving mode request of a driver, a status of the torque transfer system, and a driving mode active in the torque transfer system.

28. The control method as claimed in claim 26, wherein
a wheel lock detection signal is determined as a function of at least two wheel lock detection modes and as a function of speed of the vehicle; and
the torque transfer command is based on a driving mode request of a driver, a status of the torque transfer system, and a driving mode active in the torque transfer system.

29. The control method as claimed in claim 28, wherein a first wheel lock detection mode is selected if the driving mode request of the driver is not all-terrain, if the driving mode active in the torque transfer system is not all-terrain, if the speed of the vehicle is greater than a threshold value, or if a malfunction of the torque transfer actuator other than a thermal malfunction is detected.

30. The control method as claimed in claim 29, wherein a second wheel lock detection mode is selected if the first wheel lock detection mode has not been activated, the second wheel lock detection mode having a lower detection sensitivity than detection sensitivity of the first wheel lock detection mode.

31. The control method as claimed in claim 28, wherein
a braking detection signal is determined if a pressure of the brake system is greater than a threshold value,
the wheel antilock command is determined as a function of the wheel lock detection signal and the braking detection signal, and
a control signal for triggering the wheel antilock system is determined as a function of speed of the vehicle, the wheel antilock command, a driving mode request of the driver, and a braking request signal.

32. The control method as claimed in claim 31, wherein
a torque transfer setpoint in a two-wheel drive mode, a torque transfer setpoint in a four-wheel drive mode, a torque transfer setpoint in an all-terrain four-wheel drive mode, and a torque transfer setpoint in braking mode are determined;
a torque transfer setpoint is selected as a function of speed of the vehicle, a driving mode request of the driver, depression of a brake pedal, activation of a handbrake, and a control signal for triggering the wheel antilock system; and
the torque transfer command is emitted as a function of the torque transfer setpoint selected.
